(19) United States
(12) Patent Application Publication
(10) Pub. No.: US 2025/0277509 A1
(43) Pub. Date: Sep. 4, 2025

(54) Linear Plain Bearing

(71) Applicant: igus GmbH, Köln (DE)

(72) Inventor: Fabian Köching, Rhede (DE)

(21) Appl. No.: 18/858,734

(22) PCT Filed: Apr. 21, 2023
(86) PCT No.: PCT/EP2023/060504

§ 371 Date: Oct. 21, 2024

(30) Foreign Application Priority Data
Apr. 22, 2022 (DE) 20 2022 102 167.8

(51) Int. Cl. F16C 29/02

(52) U.S. Cl. CPC F16C 29/02

(57) ABSTRACT

A linear plain bearing (1) includes a rail (2) and a carriage (3, 41) with a complementary linear guide (4) which cooperates with the rail (2). The rail (2) is formed as a single-piece double rail (5, 40) with two parallel rail elements (6, 7, 42, 43) in a rail plane (8) and the linear guide (4) of the carriage (3, 41) has two parallel linear guide elements (9, 10) fitting the double rail (5, 40). A first of the rail elements (6, 42) and a first of the linear guide elements (9) form a guide unit (11), where a play-free or low-play sliding guiding is provided by the guide unit (11), and the second rail element (7) with the second linear guide element (10) forms a supporting guide (12).

The invention relates to a linear plain bearing comprising an elongated rail and a carriage with a complementary linear guide which cooperates with the rail, wherein the rail is formed as a single-piece double rail with two parallel rail elements and the linear guide of the carriage has two parallel linear guide elements.

Such a linear plain bearing can be used for sliding guiding of a working device. Depending on the field of application, a working device can have very diverse properties, for example it can be an element of a machine tool. Another example is a working device in the form of a holding mechanism, for example for a display, which is mounted as easily displaceable as possible. The important thing is always that the linear plain bearing enables a linear guiding of the working device fastened to it along its rail that is as low-friction and low-wear as possible, wherein at the same time the working device is to be reliably held on the rail. The invention relates for example to a linear plain bearing which can be used in vehicle construction, in particular in the case of a utility vehicle such as for instance a tractor or a cleaning vehicle. In the case of such a utility vehicle, it is often desired that a working device can be easily fastened in the cab displaceable along a longitudinal direction. In order to guarantee an easy and reliable mounting of the working device, for this the linear plain bearing is usually installed fixedly in the vehicle. For this purpose, the rail of the linear plain bearing is fastened to a vehicle part, whereas the working device can be detachably fastened to the carriage. For this, fastening mechanisms corresponding to each other are provided on the carriage and/or the working device.

In the case of a linear plain bearing which is implemented as a double rail with a carriage that fits it and has parallel linear guide elements, the spacing of the parallel rail elements always has a certain manufacturing tolerance and the dimensional stability of the rail elements has a certain dimensional tolerance. The same applies to the spacing of the parallel linear guide elements and to the dimensional tolerance of the linear guide elements which have to fit together with the rail elements.

A generic linear plain bearing which is formed as a single-piece double rail is known to a person skilled in the art from DE 20 2021 105 329 U1. On one of the two linear guide elements the known linear plain bearing has an actuating arm which is arranged transverse to the longitudinal extent of the rail and is displaceable in this transverse direction. The actuating arm is fixable and detachable in the transverse direction. For fixing, a spring element can be provided, which cooperates with the actuating arm and pretensions it against one of the rail elements in the transverse direction. The freedom from play or low play of the sliding guiding is adjusted in this way in this state of the art. The thus-achievable freedom from play or low play of the sliding guiding is perceived as structurally too elaborate.

A general state of the art is known from DE 20 2004 016 094 U1, which comprises an example of a linear plain bearing with a double rail which is composed not in a single piece but from individual rails. For this, the individual rails have to be screwed to a so-called base. In this state of the art the freedom from play or low play of the sliding guiding of the linear plain bearing goes along with the screwed mounting of the individual rails on the base. The parallel spacing of the individual rails relative to each other can be adapted, during the screwing, to the parallel spacing of the linear guide elements, or errors in parallelism or misalignments of the rails, which can occur due to mounting and/or operation, can be compensated for by means of the screw connection. This type of adjustment of the freedom from play or low play is perceived as structurally elaborate and in addition the mounting effort seems too great.

The object of the invention is to propose a structurally simplified linear plain bearing which can provide a desired freedom from play or low play and requires as little mounting effort as possible.

According to the invention, the object is achieved in that a first of the rail elements and a first of the linear guide elements form a guide unit, in that a play-free or low-play sliding guiding is provided by means of the guide unit, and in that the second rail element, with the second linear guide element, forms a supporting guide.

The solution provides that only one rail element of the double rail and only one linear guide element of the carriage need to cooperate in order to provide the lateral guiding for the linear plain bearing as a guide unit. The supporting guide, which is formed of the second rail element and the second linear guide element, substantially makes it possible to accommodate a load in a direction running orthogonal to the rail plane. It need not fulfil a lateral sliding guiding function.

In the case of a double rail of the state of the art produced in a single piece, high demands are made on the dimensional accuracy for the amount of spacing between the two parallel rail elements of the double rail, i.e., on the gauge of the double rail. Moreover, the demands on the parallelism of its rail elements are high. The design according to the invention can advantageously tolerate certain dimensional inaccuracies or larger tolerances in the gauge of the double rail. The demands on the parallelism of the two rail elements are also lower. Only one of two rail elements forms, with an allocated linear guide element, the guide unit, which alone undertakes the exact directional guiding for the movement of the carriage on the double rail. The supporting unit on the other hand is set up to compensate, to some extent, for any dimensional deviations in the gauge of the double rail and/or any deviations from the ideal parallelism. The structure thereby allows cruder size and dimensional tolerances, or larger size and dimensional tolerance zones, to be permitted during the production of the double rail. This greatly reduces the effort and the costs for producing the double rail. The structure according to the invention in addition improves the replaceability of double rails with different carriages. While according to the state of the art the gauge of the double rail had to correspond well to the gauge of the carriage, i.e., both had to lie within a narrow tolerance zone, now the tolerance zone can be made much larger. In series production this has the result that a double rail fits together with a larger number of carriages, the gauges of which lie in a larger tolerance zone.

At least one rail element of the double rail expediently has a cross section with an outer contour and at least one linear guide element of the carriage has a cross section with a complementary inner contour and/or at least one rail element of the double rail has a cross section with an inner contour and at least one linear guide element of the carriage has a cross section with an outer contour that fits it.

The linear guide of the carriage is easily set up to slide on the rail elements of the double rail by means of its two linear guide elements. For the rail elements on the one hand and the linear guide element on the other hand, different materials are expediently chosen which yield a suitable material pairing, in particular such that the material of one of the elements has a much lower coefficient of friction than the material of the other element. It is favourable if the material of the linear guide element is the one that has a lower coefficient of friction than the material of the rail element which forms the sliding surface. This has the advantage that the rail can be chosen from a material with good strength values, in particular a material with a high bending strength and a resistant surface, for example a metal, preferably aluminium or an aluminium alloy. A plastic which has the desired comparatively lower coefficient of friction than the material of the rail can, e.g., then be chosen as material for the linear guide element.

A lateral play is expediently provided between the linear guide element that is part of the supporting guide and the allocated rail element. With the built-in play, the supporting unit is easily set up to be able to compensate for any dimensional deviations in the gauge of the double rail and/or any deviations from the ideal parallelism.

It is useful if the linear guide element that is allocated to the supporting guide has an inner contour and that the cross section of the inner contour is further formed as the cross section of the outer contour of the allocated rail element.

It is often expedient to provide just the rail elements of the double rail with the outer contour and to provide the linear guide elements of the carriage, as mentioned previously, with the inner contour. This, e.g., when the double rail is arranged at the bottom and the carriage at the top. Expediently, e.g., when the inner contour has a lateral opening because the opening can then be arranged pointing downwards. As a result, no dirt can fall in and accumulate. A reversed design can be favourable for a double rail to be used suspended, with the result that the rail elements thereof are provided with the inner contour and the linear guide elements of the carriage are provided with the outer contour.

The rail element of the double rail provided with an outer contour expediently forms a rail head.

The rail head preferably has a polygonal cross section, preferably a circular cross section with cylindrical outer contour.

If the rail element belonging to the guide unit has an outer contour with polygonal cross section or a circular cross section, with a linear guide element that fits it, a centring thereof on the rail element can be brought about, and thus an exact centring and guiding of the carriage as a whole. This succeeds because a polygonal cross section and a circular cross section in each case have areas of lateral sliding surface which are arranged symmetrical to each other. A linear guide element guided sliding thereon centres itself thereon automatically.

The rail head is easily supported by a bar of the rail element.

The bar is expediently arranged on a main element of the double rail.

The rail element is formed as a single-piece rail, or as a single-piece double rail, and the bars and rail heads are preferably also integrated in a single piece. The bars and rail heads are preferably provided symmetrical to each other on the double rail.

The single-piece rail is expediently produced using a primary shaping or forming process which requires no mechanical post-processing. A rail made of metal, in particular of aluminium or an aluminium alloy, can be produced as an extrusion-moulded rail profile. A double rail produced in this way has two rail elements, which are preferably formed symmetrical. The carriage on the other hand is provided with the linear guide, which has two differently designed linear guide elements, namely the first linear guide element, with which the guide unit can always be produced, and the second linear guide element, with which the supporting guide can always be produced.

Because the rail elements are symmetrical, the first linear guide element can selectively be combined with one or other of the two rail elements. The guide unit necessarily always results. The linear guide element can likewise selectively be combined with one or other of the two rail elements and the supporting guide always results.

The linear guide element provided with an inner contour advantageously has a C-shaped cross section with a lateral opening. The lateral opening is expediently dimensioned such that the inner contour of the linear guide element envelops the rail element over a circumferential range of from 180° to 320°.

It is favourable if the bar of the double rail fits through the lateral opening of the C-shaped cross section of the linear guide element.

An embodiment in which the linear guide element that is included in the guide unit has an inner contour with a circular cross section is preferred. Within the meaning of the invention the cross section is referred to, simplified, as circular although it has a lateral opening.

The inner contour of the linear guide element that is included in the supporting guide is particularly preferably provided with an oval cross section. The oval cross section is expediently provided with a lateral opening.

In a further improved embodiment, the oval cross section of the inner contour of the linear guide element is composed of two divided circle arcs and one straight line. Within the meaning of the invention the cross section is referred to, simplified, as “oval” although it is designed as an open cross section which only has one straight line 29.

The play provided in the supporting guide is preferably a dimensional range of from 0.05 mm to 1.00 mm, in particular from 0.2 mm to 0.6 mm.

In an embodiment with oval cross section of the inner contour of the linear guide element, which is composed of two semi-circle arcs and two parallel straight lines of equal length, the play is defined quite simply by the length of a straight line of the oval, which preferably has to lie in the dimensional range mentioned for the play.

A plain bearing element can be arranged between at least one of the rail elements and one of the linear guide elements. In this case, having to form the linear guide element as a whole from a material with a low coefficient of friction can be dispensed with. It is then sufficient to form only the plain bearing element from a material with a low coefficient of friction in order to provide a low-friction contact with the rail element and smooth sliding along the rail element. For this, the plain bearing element is preferably produced from a plain bearing material, particularly preferably from a plain bearing plastic.

By a plain bearing plastic is meant within the meaning of the invention a plastic, preferably polymer, that has a lower coefficient of friction than the surface of the rail element that serves as sliding surface. In particular, this includes the thermoplastics polyethylene, polypropylene, polyacetal, polycarbonate, polyamide, polyvinyl chloride, polytetrafluoroethylene as well as, in the case of thermosets, phenolic resins. To further reduce the friction, these plastics can contain lubricants, in particular, fine-particle solid lubricants such as molybdenum disulfide or graphite. Such polymers are also referred to as tribopolymers, e.g., the product Iglidur®. With the friction, the wear reduces and the abrasion becomes less. These products are therefore advisable particularly when high purity is important. This is the case for example in the food industry and semiconductor industry, as well as in biochemical and microbiological applications. As mentioned, these polymer materials can furthermore contain fillers and fibrous materials, for example those made of plastic or textile, which improve the mechanical properties.

The plain bearing element advantageously has a sleeve-shaped plain bearing body with an inner contour, an outer contour, a centre axis and a lateral opening.

The inner contour is preferably formed polygonal and particularly preferably hollow cylindrical. The outer contour can likewise be polygonal, it is preferably cylindrical.

It is helpful if the plain bearing element provided on the side of the guide unit and the plain bearing element provided on the side of the supporting guide in each case nestles up against the cross section of the allocated rail element.

In addition it can be provided that the plain bearing element on the side of the guide unit also nestles up, with its outer contour, against the cross section of the linear guide element.

The linear guide element then surrounds/envelops the rail element indirectly, namely with interposition of the plain bearing element. The plain bearing element for its part surrounds the rail element and is directly in sliding contact with the rail element. The linear guide element likewise surrounds the rail element, but has no direct contact with it. The amount of the rail element that the plain bearing element surrounds expediently extends in a circumferential range of from 200° to 320°. The enveloped circumferential range of the linear guide element and the circumferential range enveloped by the plain bearing element are preferably identical or almost identical.

Expediently, on the side of the supporting guide, the inner contour of the linear guide element has a width which is larger than the width of the outer contour of the plain bearing element, with the result that a lateral play relative to the plain bearing element is formed. If the inner contour of the linear guide element has an oval cross section and the outer contour of the plain bearing element is cylindrical, then lateral crescent-shaped clearances are formed between the outer contour of the plain bearing element and the wide inner contour of the linear guide element. Parts of the outer contour of the plain bearing element then serve as a fastening side in order to bring the plain bearing element partially into contact with the inner contour of the linear guide element and fix it, while other partial areas of the outer contour of the plain bearing element in each case define a side of the crescent-shaped clearance. The crescent-shaped clearances are thus provided on the outside/outer contour of the plain bearing element, which merely serves for the fixing in the linear guide element. The crescent-shaped clearances are thereby provided remote from the inner contour of the plain bearing element serving as a plain bearing surface.

It is helpful if at least one of the linear guide elements has two guide sections arranged in a row, wherein the guide sections lie in a guide axis, wherein at least one of the linear guide elements has two supporting sections arranged in a row, and wherein the supporting sections lie in a supporting axis.

For an exact reliable linear bearing by means of the linear plain bearing, it is helpful if each of the two guide sections has a certain length and a certain spacing is provided between the two guide sections. Thus, a length of the guide that is favourable as a whole can be provided. Otherwise, a torque acting on the carriage could cause a jamming due to a tilting of the carriage on the rail. A tilting due to a guide that is too short would be favoured. An expedient length of the guide section lies in particular in the range of 0.1 to 1.5 times, in particular 0.2 to 1.0 times the gauge of the double rail. An expedient spacing between the guide sections arranged in a row in particular lies in the range of 0,05 to 1,0 times, in particular 0.1 to 0.7 times, in particular 0.1 to 0.5 times the gauge of the double rail.

A further usefulness results if at least one of the guide sections of the first linear guide element and at least one of the supporting sections of the second linear guide element is provided with a plain bearing element. In a simple manner, the plain bearing element can have a length which lies in the range of the expedient length of the guide section or of the supporting section respectively.

In a simple manner, all linear guide elements are provided with two guide sections, which lie one behind the other in a row, and each guide section is expediently provided with a plain bearing element. The plain bearing elements provided in a row have a spacing from each other which lies in the identical range of the mentioned expedient spacing which is provided for the guide sections.

It is also expedient if a connection means is provided for the plain bearing element, by means of which it can be connected to the linear guide element positionally fixed relative to the guide axis. The plain bearing element is to move with the carriage and therefore to be connected positionally fixed to the corresponding linear guide element of the carriage.

In a simple manner, an adhesive or a positive-locking connection can be provided as connection means.

As part of the positive-locking connection, a locking recess can be provided in the inner contour of the linear guide element.

Expediently, the plain bearing element is then provided, as a complementary part of the positive-locking connection, with a protrusion on its outer contour which is designed fitting the locking recess of the linear guide element.

In addition, the inner contour of the plain bearing element is provided with pocket-shaped recesses or with groove-shaped recesses, which extend parallel to its centre axis or helically around the centre axis. The pocket- or recesses can serve as a dust or dirt chamber. Groove-shaped recesses can act as a dirt channel, through which dirt can also exit at the front-face ends of the plain bearing element. The thus-designed linear plain bearing provides a dirt-resistant safe operation. Beyond that, only minimal running noises occur during operation, even at high speeds of the carriage relative to the rail.

The invention is illustrated by way of example in a drawing and described in detail with reference to several figures below. There are shown in:

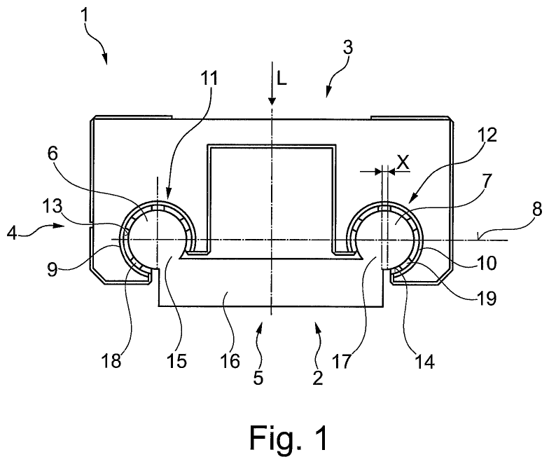

FIG. 1 a front view of a linear plain bearing according to the invention,

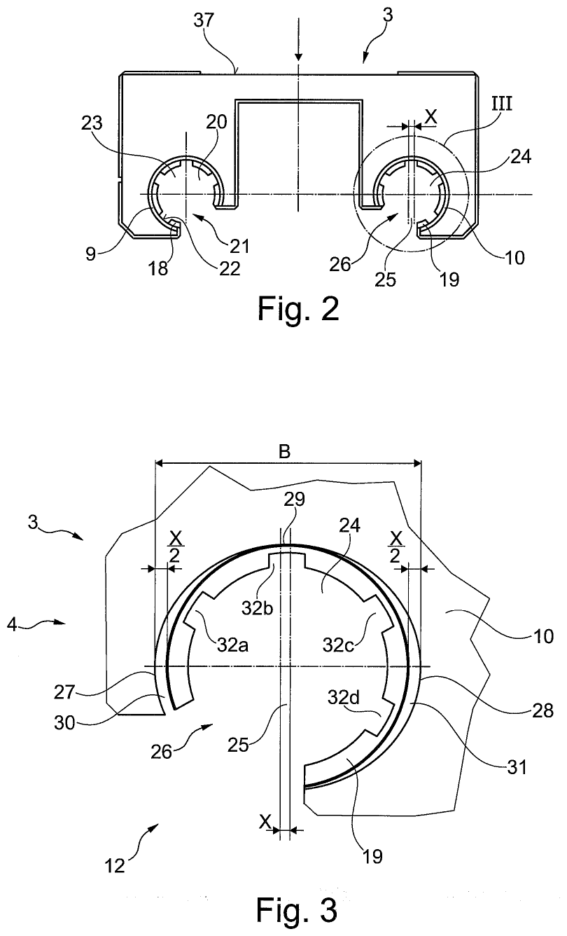

FIG. 2 a front view of the carriage of the linear plain bearing according to FIG. 1,

FIG. 3 an enlarged detail according to III in FIG. 2,

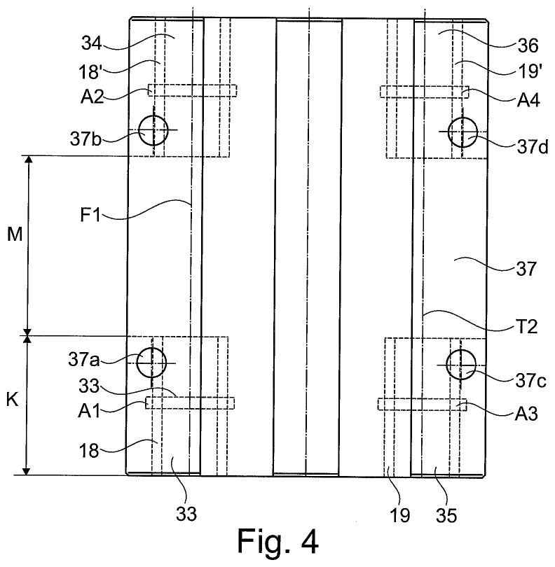

FIG. 4 a top view of the carriage according to FIG. 2,

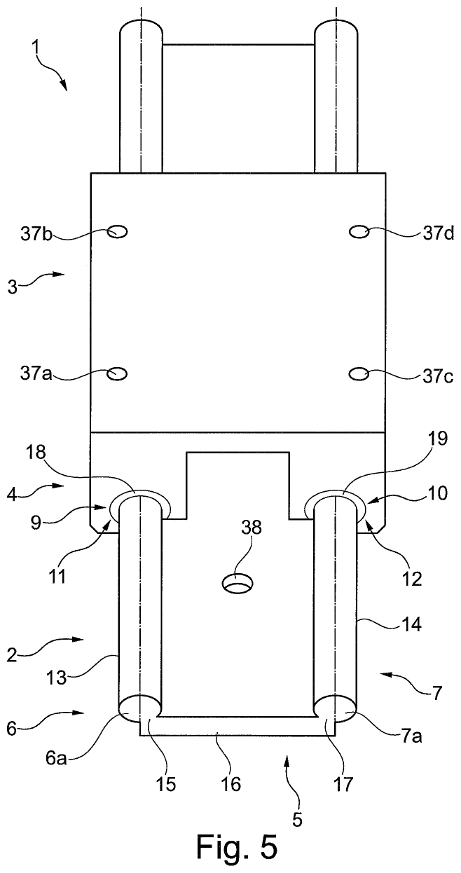

FIG. 5 a perspective view of the linear plain bearing according to FIG. 1,

FIG. 6 a front view of an alternative embodiment example of a linear plain bearing according to the invention,

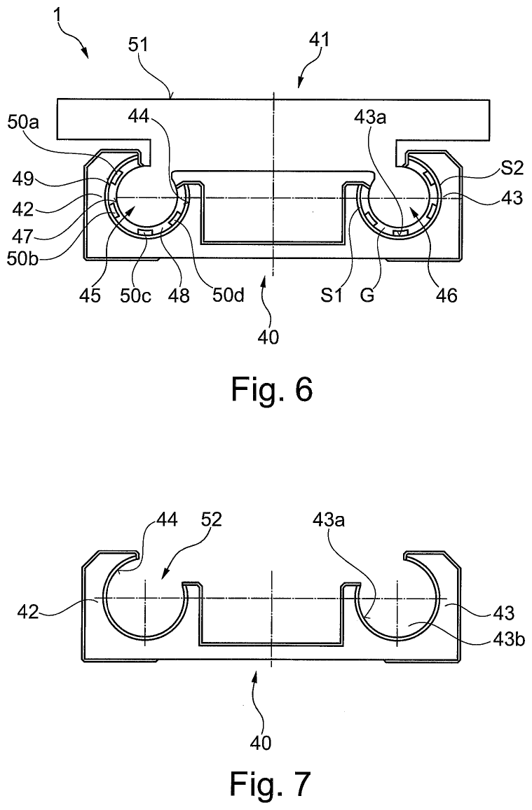

FIG. 7 a front view of the carriage of the linear plain bearing according to FIG. 6,

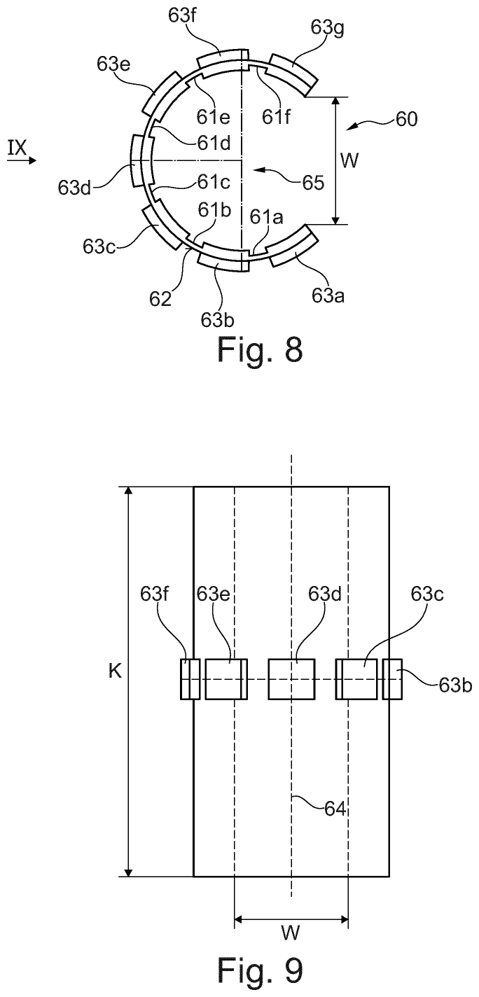

FIG. 8 a front view of a plain bearing element,

FIG. 9 a view according to IX in FIG. 8.

According to the drawing, the linear plain bearing 1 according to the invention according to FIG. 1 comprises a rail 2 and a carriage 3 with a complementary linear guide 4 which cooperates with the rail 2. The rail 2 is formed as a single-piece double rail 5 with two parallel rail elements, a first rail element 6 and a second rail element 7, which are both arranged in a common rail plane 8. The linear guide 4 of the carriage 3 has two parallel linear guide elements, a first linear guide element 9 and a second linear guide element 10, which are arranged fitting the rail elements 6 and 7 of the double rail 5.

The first rail element 6 of the double rail 5, together with the first linear guide element 9 of the carriage 3, forms a guide unit 11. A play-free or low-play sliding guiding function is provided by means of this guide unit 11. The second rail element 7, with the second linear guide element 10, forms a supporting guide 12. The supporting guide 12 substantially makes it possible to accommodate a load in a load direction L running orthogonal to the rail plane 8. The supporting guide need not fulfil a lateral sliding guiding function. An enlarged detail view of the supporting guide is illustrated in FIG. 4.

The rail elements 6 and 7 are formed as rail heads 6a and 7a, respectively. Both rail heads have a circular cross section, which in each case forms a cylindrical outer contour 13 or 14, respectively. The rail head 6a is arranged with a bar 15 on a main element 16 of the double rail 5 and the rail head 7a is arranged with a bar 17 on the main element 16. The cylindrical outer contours 13/14 in each case serve as a sliding surface for the carriage 2. In order not to produce the entire carriage from a plain bearing plastic, plain bearing elements 18 and 19 made of plain bearing plastic are provided. These plain bearing elements are fixed positionally fixed in the linear guide elements 9 and 10 of the carriage 2.

The plain bearing element 18 is designed sleeve-shaped, with a circular, or a circular ring-shaped, cross section. However, the circular ring-shaped cross section is not closed, but rather is designed as a C-shaped open cross section 20, with the result that a lateral opening 21 is formed. The bar 15 of the double rail 5 fits through the lateral opening 21. The two plain bearing elements 18 and 19 are identical and can in principle be swapped with each other.

The plain bearing elements 18 and 19 are identical. However, the manner of the bearing of the plain bearing element 19 in the linear guide element 10 differs from the bearing of the plain bearing element 18 in the linear guide element 9. This is illustrated with reference to FIGS. 2 and 3, which in each case only represent the carriage, without double rail.

According to FIG. 2 one plain bearing element 18 and 19 is represented in each of the two linear guide elements 9 and 10 of the carriage. The linear guide element 9 has an inner contour 22 with a circular cross section 23 with a lateral opening. The plain bearing element 18 is arranged concentric to the inner contour 22 of the linear guide element 9. Furthermore, the plain bearing element 18 according to FIG. 1 is also arranged concentric to the cylindrical outer contour 13 of the rail element 6.

The linear guide element 9 surrounds/envelops the rail element 6 indirectly, namely with interposition of the plain bearing element 18. Viewed in cross section, both, i.e., the linear guide element 9 and the plain bearing element 18, surround the rail element, namely in a circumferential range of approximately 290°. This results in a positive locking between the linear guide element 9 and the rail element 6. Because of the positive locking, the carriage cannot be laterally or upwardly removed from the rail. It has only one degree of freedom for its movement, namely in the direction of the longitudinal extent of the rail which is guiding it.

While the plain bearing element 18 is fixed to the linear guide element 9 positionally fixed in the translational direction of the carriage, relative to the rail head 6a it is in sliding contact with its sliding surface. In this way, the guide unit 11 is formed, which provides the play-free or low-play sliding guiding function. By play-free is meant within the meaning of the invention an almost play-free fit between linear guide element and rail element or a fit with a small elastic pretension between sliding surfaces of the linear guide element and of the rail element. With the latter measure, freedom from play can be guaranteed and how smoothly or stiffly the carriage is movable translationally on the double rail can be adjusted. By low play is meant a sliding guiding function which is equipped with a guide play between the sliding surfaces of the linear guide element and of the rail element, which is a sufficiently small guide play, which can prevent a jamming due to tilting of the carriage on the rail in the case of a torque which acts on the carriage.

Unlike the linear guide element 9, according to FIG. 2 the linear guide element 10 is provided with an inner contour 24 which has an oval cross section 25 with a lateral opening 26. The oval cross section 25, with the lateral opening 26, which is composed of two divided circle arcs 27 and 28 and one straight line 29 can best be seen in FIG. 3. In this way, the supporting guide 12 is formed by means of the oval cross section 25. The oval cross section 25 as inner contour of the linear guide element 10 has a width B which is larger than the outer diameter d of the plain bearing element 19. In this way, the outside/outer contour of the plain bearing element 19 has a lateral play 30 or 31, respectively, inside the linear guide element 10. The size of the lateral play is dimensioned according to the length X of the straight line 29 of the oval cross section 25. Through this design, the play 30 is formed as an almost crescent-shaped clearance on the divided circle arc 27 and the play 31 is formed as an almost crescent-shaped clearance on the divided circle arc 28. In FIG. 3, the plain bearing element 19 is located centrally in the oval cross section 25. The crescent-shaped clearances in each case provide a lateral play 30/31 of X/2 each, which corresponds to half of the length of the straight line 29.

With reference to FIG. 3, it is furthermore to be seen that the plain bearing element 19 has a centre axis 19a, and groove-shaped recesses 32a, 32b, 32c, 32d arranged in this axial direction are provided. The groove-shaped recesses can act as integrated dirt channels. Dirt particles can be wiped off the rail into a dirt channel and channelled out via the dirt channel.

The built-in play of the supporting guide is advantageously provided remote from the inner contour of the plain bearing element. The inner contour of the plain bearing element can thereby better serve its purpose as a plain bearing surface than known embodiments which have arranged a play in the area of the inner contour of the plain bearing element.

A top view of the carriage 3 is shown in FIG. 4. The linear guide element 9 of the carriage has two guide sections 33 and 34 arranged in a row. The guide sections lie aligned in a guide axis F1. Each of the guide sections 33 and 34 is provided with one plain bearing element 18 or 18′ each, which are identical to each other and swappable with each other.

The guide section 33 and the guide section 34 have a length K, which substantially corresponds to the length of the plain bearing element 18. A spacing M is provided between the two guide sections 33 and 34. The length K and the spacing M are dimensioned such that a jamming due to tilting of the carriage 3 on the rail 2 is counteracted.

The linear guide element 10 has two supporting sections 35 and 36 arranged in a row. The supporting sections are likewise arranged aligned. Each of the supporting sections 35 and 36 is provided with one plain bearing element 19 or 19′ each, which are identical to each other and swappable with each other. They are in addition identical to and swappable with the plain bearing elements 18 and 18′ of the guide sections 33 and 34.

The plain bearing elements 18/18′ are connected positionally fixed to the linear guide element 9 and the plain bearing elements are connected positionally fixed to the linear guide element 10. For this purpose, the linear guide element 9 is provided with locking recesses (A1, A2, A3, A4).

An upper side of the carriage 3 provides a mounting surface 37 for any working device that fits it (not represented). The mounting surface is provided with four holes 37a-d.

FIG. 5 shows a perspective view of the linear plain bearing according to FIG. 1. The double rail 5 has a length which somewhat corresponds to double the length of the carriage 3. In the area of the main element 16 of the double rail 5, a hole 38 is provided which can be used for mounting the double rail.

FIG. 6 shows a front view of an alternative embodiment example of a linear plain bearing 1 according to the invention with one rail, which is formed as a double rail 40, and a carriage 41 that fits it. The embodiment example differs from FIG. 1 in that the effective contours are swapped between the double rail and the carriage.

The double rail 40 is provided with rail elements 42 and 43, which in each case have an inner contour which serves as a sliding surface, like the hollow cylindrical inner contour 44 of the rail element 42.

Fitting this, the carriage 41 is provided with linear guide elements 45 and 46. The linear guide elements in each case have an outer contour fitting the inner contour 44. In the present example, unlike the previous example, the linear guide elements 45 and 46 of the carriage 41 are surrounded, namely by the respective rail element 42 or 43. Viewed in cross section, the surrounding here is also a circumferential range of approximately 290°. This with the effect that a positive locking results between the linear guide element 45/46 and the corresponding rail element 42/32. The positive locking has the effect that the carriage 41 cannot be removed from the rail laterally or upwardly. It has only one degree of freedom for its movement, namely in the direction of the longitudinal extent of the double rail 40 which is guiding it.

The linear guide element 45 has a cylindrical outer contour 47. A plain bearing element 48, which has a centre axis, is arranged between the outer contour 47 and the inwardly lying sliding surface of the rail element 42. The plain bearing element 48 moves together with the carriage 41 during operation. For this purpose, it is connected positionally fixed to the outer contour 47 of the linear guide element 45. The plain bearing element 48 for its part has a cylindrical outer contour 49, which cooperates with the inwardly lying sliding surface of the rail element 42 and slides thereon.

The cylindrical outer contour 49 is provided, in the axial direction, with four groove-shaped recesses 50a-d, which extend parallel to the centre axis and are open towards the outside. The groove-shaped recesses 50a-d can act as dirt channels in the built-in state of the plain bearing element 48. The rail element 43 is arranged symmetrical to the rail element 42, but has an inner contour 43a with an oval cross section 43b. The oval cross section is further formed as the hollow cylindrical inner contour 44 of the other rail element 42. Because of the larger width of the inner contour 43a, this provides a play S1 or S2 for the linear guide element 46 or for the interposed plain bearing element G respectively. The play S1/S2 is provided in the form of crescent-shaped clearances, which are provided between the outer contour of the plain bearing element G and the oval inner contour 43a.

On an upper side, the carriage 41 is provided with a mounting surface 51 which can be used for attachment of a working device.

A front view of only the double rail 40 of the linear plain bearing according to FIG. 6 is represented in FIG. 7. The inner contour 44 of the rail element 42 and the inner contour 43a of the rail element 43, which in each case form a rail channel, are to be seen. The inner contour 44 has a circular cross section, wherein the circle circumference is not completely closed, but rather has a lateral opening 52. The opening 52 is narrower than the diameter of the associated linear guide element 45. In the assembled state, therefore, the described positive locking exists, which prevents the carriage 41 from being able to detach from the double rail 40 unintentionally. The oval cross section 43b of the inner contour 43a likewise has a lateral opening 43c, which is narrower than the diameter of the associated linear guide element 46 and likewise surrounds this in a positive-locking manner.

FIG. 8 shows a front view of a further example of a plain bearing element 60, which is suitable for the first embodiment example of the invention. It has the same function and basic shape as the plain bearing elements of the first embodiment example according to FIGS. 1-3. The plain bearing element 60 shown here has an inner contour 61 to be referred to, simplified, as hollow cylindrical and a centre axis 64 and is provided with groove-shaped recesses 61a-f in the direction of this centre axis. A lateral opening 65 with a width W is provided. Unlike the plain bearing element of the first embodiment example, here merely another number of groove-shaped recesses is provided, six. Their function is identical. In the built-in state the groove-shaped recesses 61a-f can act as integrated dirt channels. Dirt particles can be wiped off a rail into a dirt channel and channelled out via the dirt channel.

On an outer contour 62, the plain bearing element 60 has several protrusions 63a-g. The protrusions 63a-g serve to make it possible to arrange the plain bearing element 60 positionally fixed in the inner contour of a linear guide element, namely in a positive-locking manner. For this purpose, the linear guide element has to be provided with a recess that fits it, for example an annular groove (not represented) in its inner contour.

FIG. 9 shows a view in the direction of the arrow IX referenced in FIG. 8. With reference to this representation, the centre axis 64 of the plain bearing element 60 is to be seen, as well as its length K, the arrangement and dimensions of the protrusions 63a-g which are arranged on its outer contour 62. Moreover, the width W of the lateral opening 65 is shown.

### List of Reference Numbers

1 linear plain bearing
2 rail
3 carriage
4 linear guide
5 double rail
6 first rail element
6a rail head
7 second rail element
7a rail head
8 rail plane
9 linear guide element
10 linear guide element
11 guide unit
12 supporting guide
13 cylindrical outer contour (first rail element)
14 cylindrical outer contour (second rail element)
15 bar
16 main element
17 bar
18 plain bearing element
18′ plain bearing element
19 plain bearing element
19′ plain bearing element
19a centre axis
20 c-shaped cross section (plain bearing 18)
21 lateral opening (plain bearing 18)
22 inner contour (first linear guide element)
23 circular cross section
24 inner contour (second linear guide element)
25 oval cross section
26 lateral opening
27 divided circle arc
28 divided circle arc
29 straight line
30 play (crescent-shaped)
31 play (crescent-shaped)
32a-d groove-shaped recess
33 guide section
34 guide section
35 supporting section
36 supporting section
37 mounting surface
37a-d hole
38 hole
40 double rail
41 carriage
42 rail element
43 rail element
43a inner contour
43b oval cross section
43c lateral opening
44 inner contour
45 linear guide element
46 linear guide element
47 outer contour (linear guide element)
48 plain bearing element
49 outer contour (plain bearing element)
50a-d groove-shaped recesses
51 mounting surface
52 lateral opening (inner contour 44)
60 plain bearing element
61 hollow cylindrical inner contour
61a-f groove-shaped recess
62 outer contour
63a-g protrusion
64 centre axis
65 lateral opening
A1 locking recess
A2 locking recess
A3 locking recess
A4 locking recess
B width
D outer diameter (plain bearing element)
F1 guide axis
G plain bearing element
K length (plain bearing element)
L load direction
M spacing (between plain bearing element)
S1 crescent-shaped clearance
S2 crescent-shaped clearance
T2 supporting axis
W width
X length

1. A linear plain bearing (1) comprising a rail (2) and a carriage (3, 41) with a complementary linear guide (4) which cooperates with the rail (2), wherein the rail (2) is formed as a single-piece double rail (5, 40) with two parallel rail elements (6, 7, 42, 43) in a rail plane (8) and the linear guide (4) of the carriage (3, 41) has two parallel linear guide elements (9, 10) fitting the double rail (5, 40), wherein one of the rail elements (6, 42) and one of the linear guide elements (9) form a guide unit (11), in that a play-free or low-play sliding guiding is provided by the guide unit (11), and the second rail element (7) with the second linear guide element (10) forms a supporting guide (12).

2. The linear plain bearing (1) according to claim 1, wherein at least one rail element (6, 7) of the double rail (5) has a cross section with an outer contour (13, 14) and at least one linear guide element (9, 10) of the carriage (3) has a cross section with a complementary inner contour (22, 24) and/or at least one rail element (42, 43) of the double rail (40) has a cross section with an inner contour (43a, 44) and at least one linear guide element (45, 46) of the carriage (41) has a cross section with an outer contour (49) that fits the at least one rail element.

3. The linear plain bearing (1) according to claim 1, wherein a lateral play (30, 31, S1, S2) is provided between the linear guide element (10, 46) that is part of the supporting guide (12) and the corresponding rail element (7, 43).

4. The linear plain bearing (1) according to claim 3, wherein the linear guide element (10) that corresponds to the supporting guide (12) has an inner contour (24), and in that the cross section of the inner contour (24) is further formed as the cross section of the outer contour (14) of the allocated rail element (7).

5. The linear plain bearing (1) according to claim 2, wherein the rail element (6, 7) of the double rail (5) provided with an outer contour forms a rail head (6a, 7a).

6. The linear plain bearing (1) according to claim 5, wherein the rail head (6a, 7a) has a polygonal, a circular, or a cross section with cylindrical outer contour (13, 14).

7. The linear plain bearing (1) according to claim 5, wherein the rail head (6a, 7a) is supported by a bar (15, 17) of the rail element (6, 7).

8. The linear plain bearing (1) according to claim 7, wherein the bar (15, 17) is arranged on a main element (16) of the double rail (5).

9. The linear plain bearing (1) according to claim 7, wherein the linear guide element (9, 10) provided with an inner contour has a C-shaped cross section (20) with a lateral opening (21).

10. The linear plain bearing (1) according to claim 9, wherein the bar (15, 17) of the double rail (5) fits through the lateral opening (21) of the C-shaped cross section (20) of the linear guide element (9, 10).

11. The linear plain bearing (1) according to claim 2, wherein the linear guide element (9) that is included in the guide unit (11) has an inner contour (22) with a circular cross section (23).

12. The linear plain bearing (1) according to claims 3, wherein the inner contour (22) of the linear guide element (10) that is included in the supporting guide (12) is provided with an oval cross section (25).

13. The linear plain bearing (1) according to claim 12, wherein the oval cross section (25) of the inner contour (22) of the linear guide element (10) is composed of two divided circle arcs (27, 28) and one straight line (29).

14. The linear plain bearing (1) according to claim 3, wherein the play (30, 31, S1, S2) provided in the supporting guide (12) is between 0.05-1.00 mm.

15. The linear plain bearing (1) according to claim 1, wherein a plain bearing element (18, 18′, 19, 19′, 48, 60) is arranged between at least one of the rail elements (6, 7, 42, 43) and one of the linear guide elements (9, 10, 45, 46).

16. The linear plain bearing (1) according to claim 15, wherein the plain bearing element (18, 18′, 19, 19′, 48, 60) has a sleeve-shaped plain bearing body with an inner contour (61), an outer contour (62), a centre axis (64), and a lateral opening (65).

17. The linear plain bearing (1) according to claim 15, wherein both the plain bearing element (18, 18′, 48) provided on the side of the guide unit (11) and the plain bearing element (19, 19′) provided on the side of the supporting guide (12) nestle up against the cross section of the corresponding rail element (6, 7, 42).

18. The linear plain bearing (1) according to claim 17, wherein the plain bearing element (18, 18′, 48) on the side of the guide unit (12) also nestles up, with its outer contour (62), against the cross section of the linear guide element (9, 45).

19. The linear plain bearing (1) according to claim 14, wherein, on the side of the supporting guide (12), the inner contour (24) of the linear guide element (10) has a width which is larger than the width or the diameter of the outer contour (62) of the plain bearing element (19, 19′, 60), with the result that a lateral play (30, 31, S1, S2) relative to the plain bearing element (19, 19′, 60) is formed.

20. The linear plain bearing (1) according to claim 1, wherein at least one of the linear guide elements (9, 45) has two guide sections (33, 34) arranged in a row, and in that the guide sections (33, 34) lie in a guide axis (F1), and in that at least one of the linear guide elements (10, 46) has two supporting sections (35, 36) arranged in a row, and in that the supporting sections (35, 36) lie in a supporting axis (T2).

21. The linear plain bearing (1) according to claim 20, wherein at least one of the guide sections (33, 34) of the first linear guide element (9) and at least one of the supporting sections (35, 36) of the second linear guide element (10) is provided with a plain bearing element (18, 18′, 19, 19′, 48, 60, G).

22. The linear plain bearing (1) according to claim 15, wherein a connection means is provided for the plain bearing element (18, 18′, 19, 19′, 48, 60, G), by which it can be connected to the linear guide element (9, 10, 45, 46) positionally fixed relative to the guide axis (F1, T2).

23. The linear plain bearing (1) according to claim 22, wherein an adhesive or a positive-locking connection is provided as the connection means.

24. The linear plain bearing (1) according to claim 23, wherein, as part of the positive-locking connection, a locking recess (A1, A2, A3, A4) is provided in the inner contour (22, 24) of the linear guide element (9, 10).

25. The linear plain bearing (1) according to claim 23, wherein the plain bearing element (18, 18′, 19, 19′, 48, 60, G) is provided, as a complementary part of the positive-locking connection, with a protrusion (63a, 63b, 63c, 63d, 63e, 63f, 63g) on its outer contour (62) which is configured to fit in the locking recess (A1, A2, A3, A4) of the linear guide element (9, 10, 45, 46).

26. The linear plain bearing (1) according to claim 15, wherein the inner contour of the plain bearing element (18, 18′, 19, 19′, 48, 60, G) is provided with pocket-shaped recesses or with groove-shaped recesses (32a, 32b, 32c, 32d, 61a, 61b, 61c, 61d, 61e, 61f), which extend parallel to the centre axis (64) or helically around the centre axis (64).
